(19) United States
(12) Patent Application Publication
(10) Pub. No.: US 2011/0072640 A1
(43) Pub. Date: Mar. 31, 2011

(54) METHODS FOR MODIFYING SEALING SYSTEMS FOR ROTARY MACHINES

(75) Inventors: Eric John Ruggiero, Rensselaer, NY (US); Nitin Bhate, Bangalore (IN); Daniel James Fitzmorris, Clifton Park, NY (US); Anthony James George, Clifton Park, NY (US)

(73) Assignee: GENERAL ELECTRIC COMPANY, Schenectady, NY (US)

(21) Appl. No.: 12/960,084

(22) Filed: Dec. 3, 2010

Related U.S. Application Data
(62) Division of application No. 12/135,379, filed on Jun. 9, 2008.

(51) Int. Cl. H02K 15/00

(52) U.S. Cl. 29/596

(57) ABSTRACT

A method for modifying a sealing system of a hydrogen-cooled generator includes coupling to a sealing device of the generator a contacting seal comprising a plurality of non-metallic bristles projecting from an aluminum body with tips of the bristles engaging a rotor of the generator. Another method includes removing a portion of a non-contacting seal, providing a replacement sealing device comprising an aluminum body and a plurality of non-metallic bristles projecting therefrom, and replacing the removed portion of the non-contacting seal by coupling the aluminum body to the non-contacting seal such that tips of the bristles contact the rotor. Another method includes removing an original sealing device, providing a replacement sealing device comprising an aluminum body and a plurality of non-metallic bristles projecting therefrom, and inserting the replacement sealing device into the generator such that tips of the bristles contact a rotor of the generator.

### CROSS REFERENCE TO RELATED APPLICATIONS

This application is a divisional application to U.S. patent application Ser. No. 12/135379, entitled “SEALING SYSTEMS FOR ROTARY MACHINES AND METHODS FOR MODIFICATION”, filed Jun. 9, 2008, which is herein incorporated by reference in its entirety.

### BACKGROUND

The invention relates generally to rotary machines and more particularly to sealing systems and methods for modifying inner oil deflectors in hydrogen-cooled generators.

In turbo-machinery such as gas turbines, steam turbines, compressors, and turbo-pumps, seals are used at different locations for minimizing leakage flows. For example, seals may be provided between sealing surfaces which are both movable relative to one another or between components in which one component moves relative to another component, e.g., a housing wall and a rotating shaft.

In an example including a hydrogen-cooled generator, a housing or casing surrounds a rotor, and seals are interposed between the housing wall and the rotor to seal between a hydrogen atmosphere on one side of the housing wall and oil (or oil mist) and air on the opposite side of the housing wall in a bearing cavity. Various approaches have been designed to maintain hydrogen purity and reduce hydrogen consumption.

In one example, a bolted, babbitted seal ring design has been used to lower the oil flow required of the shaft seals configured for sealing hydrogen gas in the end cavity from ambient air. This embodiment requires a re-design of the end shield structure of the generator.

In another example, hydrogen purity is improved by vacuum treating the seal oil to remove entrained impurities prior to pumping the seal oil into the hydrogen shaft seals. This embodiment results in pure hydrogen in the end cavities and thus eliminates the need for a diffusion barrier. Vacuum treatment systems are expensive and require additional power plant equipment and controls.

There is a need for a less complex system and method for maintaining hydrogen purity and reducing hydrogen consumption. There is a need to have non-sparking sealing materials in hydrogen-cooled generators, at locations where combustible mixtures of hydrogen and air could be present.

### BRIEF DESCRIPTION

In accordance with one exemplary embodiment of the present invention, a rotary machine includes a sealing device disposed between a rotor and a stator. The sealing device is configured for at least partially segregating a first fluid cavity on one side of the sealing device and a second cavity on an opposite side of the sealing device. The sealing device includes a non-contacting seal. The sealing device further includes a contacting seal including an aluminum body coupled to the non-contacting seal and a plurality of non-metallic bristles projecting from the aluminum body with tips of the bristles engaging the rotor of the rotary machine.

In accordance with another exemplary embodiment of the present invention, a hydrogen-cooled generator includes a sealing device disposed between a rotor and a stator. The sealing device is configured for at least partially segregating hydrogen atmosphere on one side of the sealing device and a cavity on an opposite side of the sealing device. The sealing device includes a non-contacting seal. The sealing device further includes a contacting seal including an aluminum body coupled to the non-contacting seal and a plurality of non-metallic bristles projecting from the aluminum body with tips of the bristles engaging the rotor of the generator.

In accordance with another exemplary embodiment of the present invention, a method for modifying a hydrogen-cooled generator is disclosed. The method includes coupling to a sealing device, a contacting seal including a plurality of non-metallic bristles projecting from an aluminum body with tips of the bristles engaging a rotor of the hydrogen-cooled generator.

In accordance with another exemplary embodiment of the present invention, a method for modifying a hydrogen-cooled generator is disclosed. The method includes removing at least a portion of a non-contacting seal and replacing the removed portion with an aluminum body and a plurality of non-metallic bristles projecting from the aluminum body to form a replacement sealing device. The method further includes inserting the replacement sealing device such that tips of the bristles contact a rotor so as to prevent flow or diffusion of one or more contaminants from the cavity to the hydrogen chamber.

In accordance with another exemplary embodiment of the present invention, a method for modifying a hydrogen-cooled generator is disclosed. The method includes removing an original sealing device from the hydrogen-cooled generator. The method also includes providing a replacement sealing device including an aluminum body and a plurality of non-metallic bristles projecting from the aluminum body. The method further includes inserting the replacement sealing device into the hydrogen-cooled generator such that tips of the bristles contact a rotor of the hydrogen-cooled generator so as to prevent flow or diffusion of one or more contaminants from the cavity to the hydrogen chamber.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical view of a hydrogen-cooled generator having a sealing device in accordance with an exemplary embodiment of the present invention;

FIG. 2 is a conventional sealing device provided in a hydrogen-cooled generator;

FIG. 3 is a diagrammatical view of a sealing device in accordance with the aspects illustrated in FIG. 1;

FIG. 4 is a diagrammatical view of a brush seal of the sealing device in accordance with an exemplary embodiment of the present invention;

FIG. 5 is a diagrammatical view of a sealing device having a plurality of brush seals in accordance with an exemplary embodiment of the present invention; and

FIG. 6 is a diagrammatical view of a sealing device disposed in a hydrogen-cooled generator in accordance with an exemplary embodiment of the present invention.

### DETAILED DESCRIPTION

As discussed in detail below, embodiments of the present invention provide a rotary machine having a sealing device disposed between a rotor and a stator. In one exemplary embodiment, the rotary machine includes a hydrogen-cooled generator having a sealing device disposed between a rotor and a stator. The sealing device is configured for at least partially segregating a hydrogen atmosphere on one side of the sealing device and a cavity on an opposite side of the sealing device. The exemplary sealing device includes a non-contacting seal and a contacting seal including an aluminum body coupled to the non-contacting seal and a plurality of non-metallic bristles projecting from the aluminum body with tips of the bristles engaging the rotor of the hydrogen-cooled generator. In accordance with certain embodiments of the present invention, a method for modifying a hydrogen-cooled generator including a sealing device is disclosed. In one embodiment, a brush seal is coupled to an existing inner oil deflector of the hydrogen-cooled generator. In another embodiment, a portion of the inner oil deflector is replaced by a brush seal. In yet another embodiment, the entire inner oil deflector is replaced by a new sealing device that includes a brush seal. The exemplary brush seal may comprise a plurality of non-metallic bristles, e.g. aramid filaments. The brush seal provides an effective molecular diffusion barrier between a generator winding cavity containing pure hydrogen and an end cavity containing hydrogen contaminated with oil mist and air. The barrier is helpful to maintain higher hydrogen purity in the winding cavity and results in less hydrogen being scavenged. As a result, hydrogen consumption is reduced and power efficiency of the generator is improved. As used herein, “a” and “an” do not denote a limitation of quantity, but rather denote the presence of at least one of the referenced items.

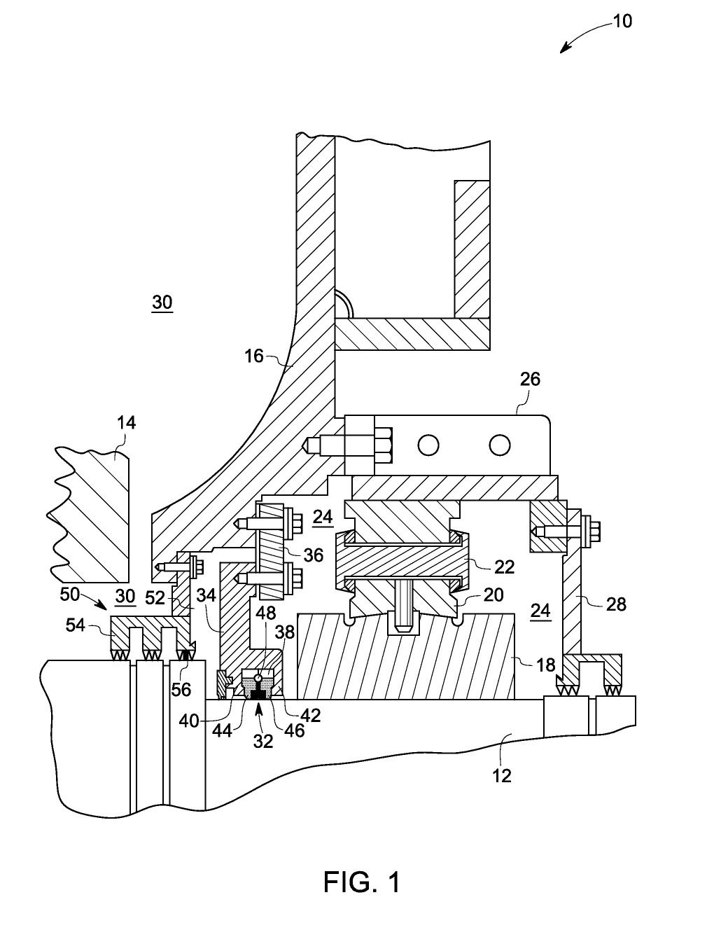

Referring now to the drawings, particularly to FIG. 1, a hydrogen-cooled generator 10 having a rotor 12, a housing wall or stator 14, and a portion of an end shield 16 is illustrated. Also illustrated is a rotor shaft bearing 18 having an inner and outer bearing ring 20 and 22, respectively, disposed in a bearing cavity 24 containing oil, oil mist, and air. A bearing cap 26 and an end oil deflector 28 are provided at an outer side to close the bearing cavity 24.

Along an inner surface of the end shield 16 (to the left of shield 16 in FIG. 1) and along inner surface of housing wall 14, a hydrogen atmosphere (generator cavity) designated by reference numeral 30 is provided for cooling the generator. A low flow fluid film seal, designated by reference numeral 32, is provided between the rotor 12 and the housing wall or stator 14. The end shield 16 and stator 14 is configured to maintain the hydrogen atmosphere (first fluid cavity) 30 segregated from the fluid in bearing cavity (second fluid cavity) 24. A seal casing 34 is interposed between the end shield 16 and rotor 12. The seal casing 34 includes an annular plate or ring secured to an insulation 36 along its radially outer diameter by bolts passing through the insulation 36. As illustrated, the seal casing 34 includes an annular chamber 38 opening radially inwardly towards the rotor 12 and defined between a pair of axially spaced flanges 40 and 42. A pair of low clearance seal rings 44 and 46 are provided within the annular chamber 38. An annular garter spring 48 engages against inclined surfaces (not shown) along radial outermost portions of the seal rings 44 and 46, respectively. The spring 48 biases the seal rings 44 and 46 along axial and radial directions. It will be appreciated that the chamber 38 is provided with oil under pressure to provide a thin film of oil along the surface of rotor 12.

An inner oil deflector (sealing device) 50 is disposed between the end shield 16 and rotor 12 inboard of the seal casing 34 defining a seal cavity 52 therebetween. As a result, the seal cavity 52 contains a significantly lesser purity of hydrogen than the hydrogen atmosphere 30. The exemplary inner oil deflector 50 includes a non-contacting seal support element 54, such as a labyrinth seal, and a contacting seal 56, such as a brush seal. The inner oil deflector prevents diffusion and mass transfer of one or more contaminants from the seal cavity 52 to the hydrogen atmosphere 30. The details of the inner oil deflector are explained in greater detail with reference to subsequent figures. It should be noted herein that the brush seal 56 may be provided at any location in the generator where combustible mixtures of hydrogen and air could be present.

It should be noted herein that the exemplary sealing device is also applicable to other rotary machines where the sealing device is configured to segregate one gaseous fluid from another gaseous fluid or a gaseous medium from a liquid medium with a lower pressure differential across the seal.

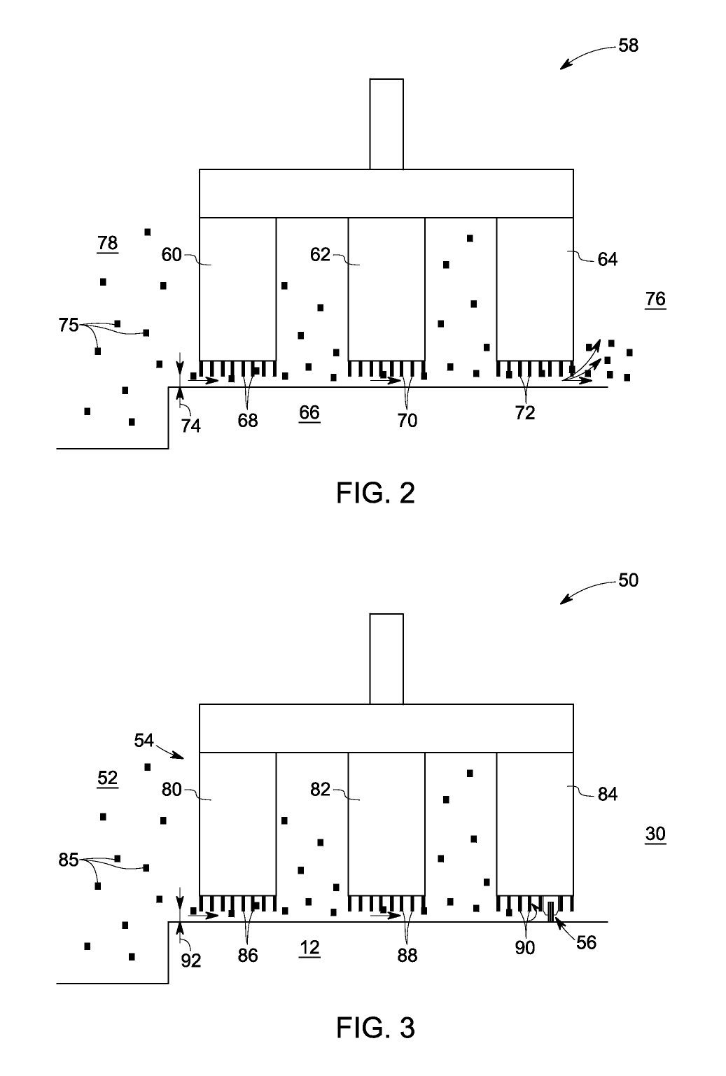

Referring now to FIG. 2, a conventional inner oil deflector 58 provided in a hydrogen-cooled generator is illustrated. The inner oil deflector 58 includes a plurality of non-contacting seals situated on seal support elements 60, 62, and 64 and disposed facing a rotor 66. The non-contacting seals may include a plurality of labyrinth teeth 68, 70, and 72 respectively protruding towards the rotor 66. It should be noted herein that in the conventional system, a gap 74 exists between the labyrinth- teeth 68, 70, and 72 and the rotor 66. The inner oil deflector 58 is configured to at least partially segregate a hydrogen atmosphere 76 on one side of the inner oil deflector 58 from a seal cavity 78 on an opposite side of the inner oil deflector 58.

In the conventional system, an end shield structure of the generator may be too flexible and thus may deflect to such an extent that lower oil flow, bolted hydrogen seal rings cannot be used. Rather, higher oil flow, unbolted hydrogen seal rings are typically used. As a consequence of the higher oil flow, an increased level of dissolved air is released from the seal oil, which migrates from the seal cavity 78 to the cavity with hydrogen atmosphere 76 through the gap 74. The gap 74 is a pathway for impurities 75 (air molecules) to diffuse across into the cavity of hydrogen atmosphere 76 resulting in contamination of hydrogen and subsequent lowering of generator efficiency. One option to control diffusion of impurities is to increase hydrogen scavenging rates. Scavenging refers to extracting impure hydrogen at a controlled flow rate from seal cavity 78 and replenishing it with an equal volume of pure hydrogen from the cavity with the hydrogen atmosphere 76 across the gap 74; thus removing impurities and inhibiting the flow of impurities from the seal cavity 78 to the cavity with the hydrogen atmosphere 76. However, these scavenging flow rates must be small so as to consume no more than a predefined economical volume of hydrogen. These predefined flow rates are too small to adequately prevent diffusion and mass transfer from the seal cavity 78 to the cavity with hydrogen atmosphere 76. Likewise, increasing scavenging rates may exceed predefined hydrogen consumption limits and often have little effect to improve purity of hydrogen.

Referring now to FIG. 3, an inner oil deflector 50 in accordance with the aspects of FIG. 1 is illustrated. In the illustrated embodiment, the exemplary inner oil deflector 50 includes the non-contacting seal support element 54 and the contacting seal 56. The inner oil deflector 50 prevents diffusions of one or more contaminants from the seal cavity 52 to the hydrogen atmosphere 30. In the illustrated embodiment, the non-contacting seal support element 54 includes a plurality of seal support elements 80, 82, and 84 disposed facing the rotor 12. The seal support elements 80, 82, and 84 may include, for example, a plurality of labyrinth-teeth 86, 88, and 90 respectively protruding towards the rotor 12. In one embodiment the seal support elements 86, 88, and 90 comprise an aluminum material. In a more specific embodiment, the seal support elements 80, 82, and 84 and teeth 86, 88, and 90 are fabricated from cast aluminum. If desired, the seal support element 84 itself may comprise the aluminum body into which brush seal bristles are inserted. Alternatively, an aluminum body element may hold the brush seal bristles and be connected to the seal support element.

It should be noted herein that in the exemplary system, the brush seal 56 is coupled to seal support element 84, which also includes labyrinth teeth 90. The brush seal 56 extends across a gap 92 between the labyrinth-teeth 86, 88, and 90 and the rotor 12 and engages the rotor 12. The inner oil deflector 50 is configured to at least partially segregate a hydrogen atmosphere 30 on one side of the inner oil deflector 50 from the seal cavity 52 on an opposite side of the inner oil deflector 50. The brush seal 56 is configured to prevent diffusion of contaminants 85 such as gaseous impurities, and oil mist from the seal cavity 52 to the cavity with hydrogen atmosphere 30. The exemplary brush seal 56 helps the inner oil deflector 50 to act as a contacting seal and thus close the gap 92 that impurities diffuse across from the seal cavity 52 to the cavity with hydrogen atmosphere 30.

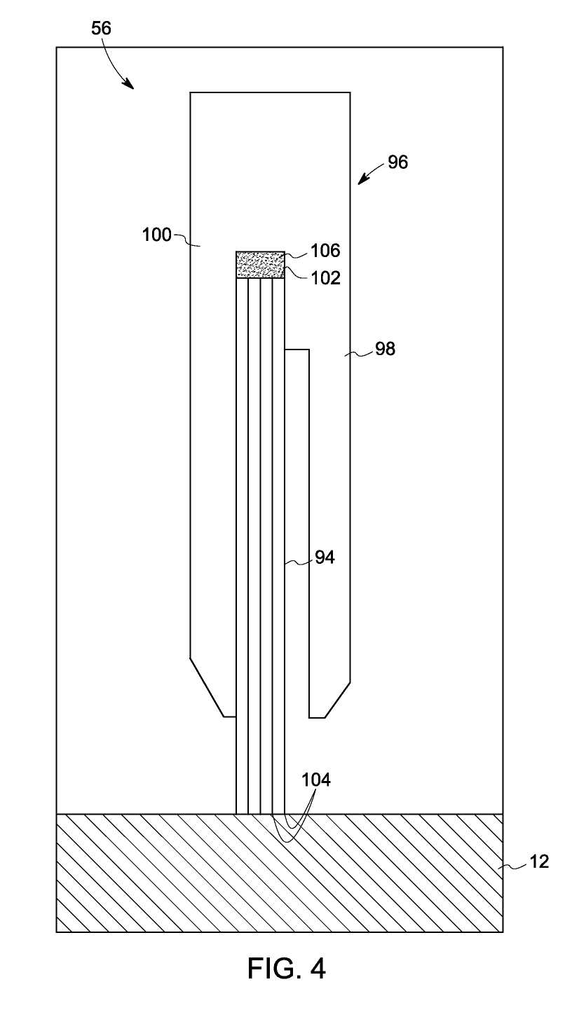

Referring to FIG. 4, a detailed view of an exemplary brush seal 56 is illustrated. The brush seal 56 in accordance with certain aspects of the present invention includes a plurality of non-metallic fibers 94 configured to contact the rotor 12 to reduce diffusion of contaminants such as air molecules and oil from the seal cavity to the cavity with hydrogen atmosphere.

In one embodiment, the brush seal 56 includes a holding device 96, which is coupled to a respective seal support element. The holding device 96 includes a first plate (front plate) 98 and a second plate (back plate) 100. The plurality of non-metallic fibers 94 are disposed between the first plate 98 and the second plate 100 of the holding device 96. Typically, the fibers 94 may be canted at a predetermined angle. As known to those skilled in the art, the canting of fibers 94 improves the compliance of the seal with the rotor 12. Such radial deflection of the fibers 94 advantageously ensures “gentle ride” over the contact surfaces to prevent structural deformation of the fibers. The cant angle depends on trade-off relationship between factors such as, for example, structural stability of the fibers and ease of assembling the fibers 94 with the plates 98, 100. The fibers 94 sandwiched between the plates 98 and 100 are packed densely enough to prevent diffusion of contaminants such as air molecules and oil mist. The packing density of the fibers is maintained within predetermined limits in such a way so as to enhance sealing effectiveness and avoid any significant increase of frictional force arising due to frictional contact between the fibers and contact surfaces.

Each fiber 94 includes a first end 102 coupled to the holding device 96 and a second end 104 configured to contact the rotor 12. The coupling may be accomplished through any conventional brush seal methodology with one example including first and second plates 98 and 100 and either an affixing material 106 such as an epoxy or a mechanical fastener such as a clamp (not shown). In certain exemplary embodiments, holding device 96 comprises an aluminum material. It should be noted herein that aluminum has the advantages that it does not spark and would not score the rotor in the event of contact. Aluminum is much easier to work with compared to other materials known to those skilled in the art. The first end 102 of each fiber 94 is coupled to the holding device 96 and the second end 104 protrudes from the holding device 96 towards the rotor 12.

In the exemplary embodiment, the non-metallic fibers may include aramid filaments such as Kevlar fibers. It should be noted herein that other non-metallic fibers are also envisaged. Fiber materials and diameters are chosen depending on trade-off relationships among properties such as stiffness, creep resistance, wear resistance, and chemical inertness against oil, for example. Fiber diameters are chosen to ensure structural stability against aerodynamic forces applied thereupon by the working fluid while considering trade-off factors such as structural stability and desired compliance. For example, smaller diameters (i.e. diameters less than 0.002 inches including Kevlar aramid fibers at 0.0005 inches and carbon fiber at 0.00025 inches) of non-metallic fibers result in lower effective clearance at the seal-rotary component interface and also lower stiffness resulting in lower heat generation. In the illustrated exemplary embodiment, Kevlar fibers are capable of withstanding the high surface speeds of generator rotor. As a result, higher hydrogen purity can be maintained in the cavity with hydrogen atmosphere by using the fibers 94 to close the gap between the non-rotating plates 98, 100 and the rotor 12.

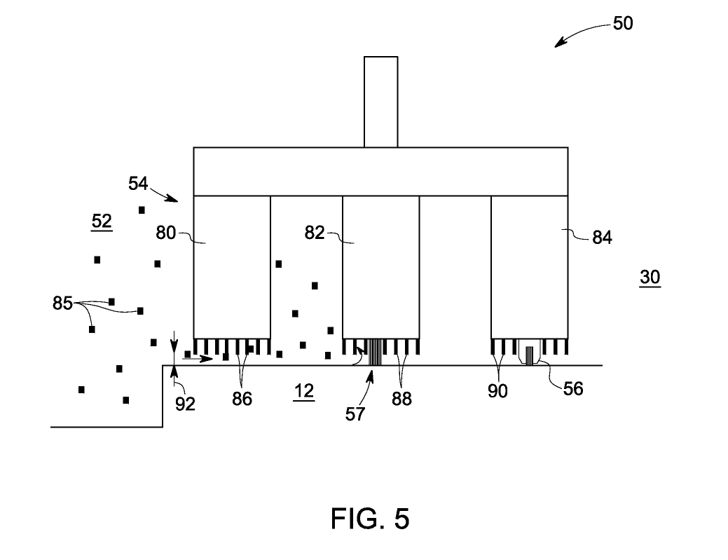

Referring to FIG. 5, an inner oil deflector 50 in accordance with another exemplary embodiment of the present invention is illustrated. In the illustrated embodiment, exemplary inner oil deflector 50 includes the seal support element 54 and the contacting seals (brush seals) 56, 57. In the illustrated embodiment, the brush seals 56, 57 act as replacement seals. In the illustrated embodiment, the seal support element 54 includes a plurality of seal support elements 80, 82, and 84 disposed facing the rotor 12. The seal support elements 80, 82, and 84 include a plurality of labyrinth teeth 86, 88, and 90 respectively protruding towards the rotor 12.

In the exemplary embodiment, some the labyrinth-teeth 88, 90 are removed from the seal support elements 82 and 84 respectively. The removed portions are replaced by a plurality of brush seals 57, 56. It should be noted herein that in the exemplary system, the brush seals 56, 57 are coupled to the seal support elements 84, 82 respectively. The brush seals 56, 57 extend across a gap 92 between the labyrinth-teeth 80, 82, and 84 and the rotor 12 and engage the rotor 12. In the illustrated embodiment, the brush seal 57 includes bristles directly coupled to the seal support element 82. In other words, the seal support element 82 itself acts as an aluminum body for holding the bristles. The inner oil deflector 50 is configured to segregate or at least partially segregate a hydrogen atmosphere 30 on one side of the inner oil deflector 50 from the seal cavity 52 on an opposite side of the inner oil deflector 50. The brush seals 56, 57 are configured to prevent diffusion of contaminants 85 such as gaseous impurities, oil mist, and oil from the seal cavity 52 to the cavity with hydrogen atmosphere 30. The exemplary brush seals 56, 57 facilitate the inner oil deflector 50 to act as a contacting seal and thus, close the gap 92 that impurities easily diffuse across from the seal cavity 52 to the cavity with hydrogen atmosphere 30.

It should be noted herein even though two brush seals are illustrated; in certain other embodiments a single brush seal may be inserted or more than two brush seals may be provided. In one embodiment, each of the seal support elements 80, 82, and 84 may be provided with one or more brush seals. In certain other embodiments, the number of brush seals provided to the seal support elements 80, 82, and 84 may vary among each other. All such permutations and combinations are envisaged. In one embodiment, the brush seals may be bolted to the seal support elements. In another embodiment, grooves may be formed in the seal support elements and the brush seals may be coupled to the grooves in the seal support elements. Each brush seal serves as both an oil barrier and as a diffusion barrier. The bristles engage the rotor directly, unlike non-contacting labyrinth teeth, and, as a result, the seal has superb oil leakage prevention and diffusion reducing characteristics. The brush seal can be adapted to fit into existing inner oil deflector designs on generators, thus making provision of brush seals an interchangeable and efficient solution. The labyrinth teeth serve as a sturdy back up seal in the event the brush seal were severely damaged or worn, allowing the generator to continue operation.

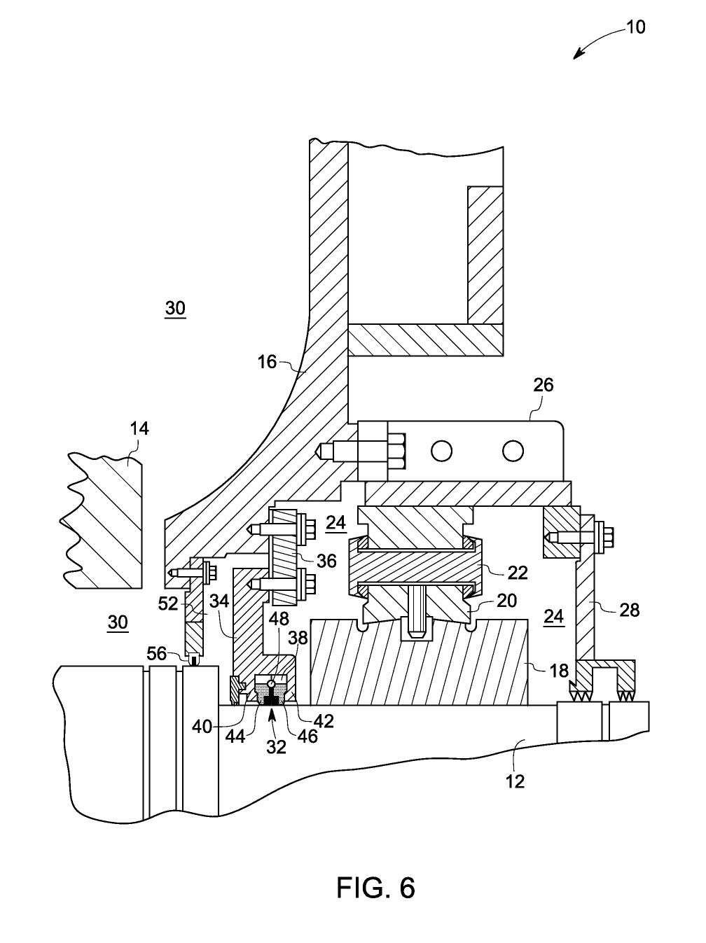

Referring now to FIG. 6, a hydrogen-cooled generator 10 in accordance with an exemplary embodiment of the present invention is illustrated. The generator 10 is structurally similar to the embodiment illustrated in FIG. 1, except that an inner oil deflector (original sealing device) 50 disposed between the end shield 16 and rotor 12 inboard of the seal casing 34 is removed. In the illustrated embodiment, the inner oil deflector 50 is replaced by a replacement sealing device, in one embodiment, the brush seal 56. The efficient oil leakage and diffusion prevention traits of the fiber brush seal would enable the rotor length to be shortened by eliminating the need for multiple tooth labyrinth, non-contacting seals. Reduced diffusion of impurities across the gap between the seal and the rotor enables higher hydrogen purity to be maintained in the cavity of hydrogen atmosphere resulting in higher power efficiency of the generator.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for modifying a hydrogen-cooled generator comprising a sealing device comprising a non-contacting seal configured to segregate a hydrogen chamber disposed on one side of the sealing device from a cavity disposed on another side of the sealing device, the method comprising:
coupling to the sealing device a contacting seal comprising a plurality of non-metallic bristles projecting from an aluminum body with tips of the bristles engaging a rotor of the hydrogen-cooled generator.

2. The method of claim 1, wherein the non-contacting seal comprises labyrinth teeth and wherein coupling the contacting seal comprises coupling the aluminum body to a non-contacting seal support element.

3. The method of claim 1, wherein the bristles comprise aramid filaments.

4. The method of claim 1, comprising clamping an end of each bristle among the plurality of non-metallic bristles between a first plate and a second plate of the aluminum body.

5. The method of claim 1, comprising engaging another end of each bristle among the plurality of non-metallic bristles to the rotor to prevent diffusion of gaseous impurities from the cavity to the hydrogen chamber.

6. The method of claim 1, comprising engaging another end of each bristle among the plurality of non-metallic bristles to the rotor to prevent diffusion of oil from the cavity to the hydrogen chamber.

7. A method for modifying a hydrogen-cooled generator comprising a sealing device comprising a non-contacting seal configured to segregate a hydrogen chamber disposed on one side of the sealing device from a cavity disposed on another side of the sealing device, the method comprising:
removing at least a portion of the non-contacting seal;
providing a replacement sealing device comprising an aluminum body and a plurality of non-metallic bristles projecting from the aluminum body;
replacing the removed portion of the non-contacting seal by coupling the aluminum body to the non-contacting seal such that tips of the bristles contact a rotor so as to prevent flow or diffusion of one or more contaminants from the cavity to the hydrogen chamber.

8. The method of claim 7, wherein the non-contacting seal comprises a plurality of labyrinth teeth and wherein removing at least a portion of the non-contacting seal comprises removing at least some of the labyrinth teeth.

9. The method of claim 7, wherein the bristles comprise aramid filaments.

10. The method of claim 7, comprising clamping an end of each bristle among the plurality of non-metallic bristles between a first plate and a second plate of the aluminum body.

11. The method of claim 7, comprising engaging another end of each bristle among the plurality of non-metallic bristles to the rotor to prevent diffusion of gaseous impurities from the cavity to the hydrogen chamber.

12. The method of claim 7, comprising engaging another end of each bristle among the plurality of non-metallic bristles to the rotor to prevent diffusion of oil from the cavity to the hydrogen chamber.

13. A method for modifying a hydrogen-cooled generator comprising an original sealing device comprising a labyrinth-toothed seal configured to segregate a hydrogen chamber disposed on one side of the original sealing device from a cavity disposed on another side of the original sealing device, the method comprising:
removing the original sealing device from the hydrogen-cooled generator;
providing a replacement sealing device comprising an aluminum body and a plurality of non-metallic bristles projecting from the aluminum body;
inserting the replacement sealing device into the hydrogen-cooled generator such that tips of the bristles contact a rotor of the hydrogen-cooled generator so as to prevent flow or diffusion of one or more contaminants from the cavity to the hydrogen chamber.

14. The method of claim 13, wherein the bristles comprise aramid filaments.

15. The method of claim 13, wherein providing the replacement sealing device comprises providing a new sealing device.

16. The method of claim 13, wherein providing the replacement sealing device comprises machining out a portion of the original sealing device and then mechanically coupling the aluminum body to original sealing device.

17. The method of claim 13, further comprising engaging an end of each bristle among the plurality of non-metallic bristles to the rotor to prevent diffusion of gaseous impurities, oil, or combinations thereof from the cavity to the hydrogen chamber.
